(19) United States
(12) Patent Application Publication
(10) Pub. No.: US 2026/0253465 A1
(43) Pub. Date: Aug. 27, 2026

(54) SYSTEMS AND METHODS FOR PERFORMANCE EVALUATION ON AUTOMOTIVE VEHICLES

(71) Applicant: Torc Robotics, Inc., Blacksburg, VA (US)

(72) Inventors: Adarsh Raj Kadungoth Sreeraj, Austin, TX (US); Robert Henry Forsyth, Blacksburg, VA (US)

(21) Appl. No.: 19/064,329

(22) Filed: Feb. 26, 2025

(51) Int. Cl. G07C 5/08; B60W 50/02; G07C 5/00; B60W 50/029

(52) U.S. Cl. CPC G07C 5/0841; B60W 50/0205; G07C 5/008; G07C 5/0808; G07C 5/0816; B60W 50/029

(57) ABSTRACT

A performance evaluation system for evaluating performance of a base vehicle of an autonomous vehicle, is provided. The system includes one or more communication connectors and an evaluation computing device. The evaluation computing device is programmed to establish an interface between the evaluating computing device and a base vehicle of an autonomous vehicle by: connecting, to one or more channels in a communication network between the base vehicle and an autonomy computing system of the autonomous vehicle, initiating a test plan including at least one unit test of an operation of the unit and a requirement of the operation; transmitting a control signal of the operation to the unit, receiving a feedback signal from the unit, analyzing the feedback signal against the requirement, evaluating performance of the unit based on the analysis; and generating a report of the performance.

### TECHNICAL FIELD

The field of the disclosure relates generally to automotive vehicles and, more specifically, to system and methods for evaluating the performance an autonomous vehicle.

### BACKGROUND OF THE INVENTION

Performance of an autonomous vehicle needs to be evaluated to make sure the performance meets requirements stipulated under standards. Conventional methods for evaluating an autonomous vehicle are largely manual, which include manually testing, manually tallying testing results, and/or manually generating reports of the testing. Manual evaluation processes introduce opportunities for human error and inconsistencies. Accordingly, improved systems and methods for evaluating vehicle functionalities are desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a performance evaluation system for evaluating performance of a base vehicle of an autonomous vehicle is provided. The system includes one or more communication connectors and an evaluation computing device comprising at least one processor in communication with at least one memory device. The at least one processor is programmed to: establish an interface between the evaluating computing device and a base vehicle of an autonomous vehicle by connecting, via the one or more communication connectors, to one or more channels in a communication network between the base vehicle and an autonomy computing system of the autonomous vehicle. The at least one processor is further programmed to initiate a test plan of a unit of the base vehicle, the test plan including at least one unit test of an operation of the unit and a requirement of the operation, transmit a control signal of the operation to the unit over the communication network, receive a feedback signal from the unit in response to the control signal over the communication network, analyze the feedback signal against the requirement, evaluate performance of the unit based on the analysis, and generate a report of the performance.

In another aspect, method for evaluating performance of an autonomous vehicle is provided. The method includes establishing an interface between the evaluating computing device and a base vehicle of an autonomous vehicle by connecting, via one or more communication connectors, to one or more channels in a communication network between the base vehicle and an autonomy computing system of the autonomous vehicle. The method also includes initiating a test plan of a unit of the base vehicle. The test plan includes at least one unit test of an operation of the unit and a requirement of the operation. The method also includes transmitting a control signal of the operation to the unit over the communication network, receiving a feedback signal from the unit in response to control signal over the communication network, analyzing the feedback signal against the requirement, evaluating performance of the unit based on the analysis, and generating a report of the performance.

In yet another aspect, one or more non-transitory computer-readable media for evaluating performance of an autonomous vehicle is provided. The non-transitory computer-readable media cause a system to establish an interface between an evaluating computing device and a base vehicle of an autonomous vehicle by connecting, via one or more communication connectors, to one or more channels in a communication network between the base vehicle and an autonomy computing system of the autonomous vehicle. The non-transitory computer-readable media further causes the system to initiate a test plan of a unit of the base vehicle, the test plan including at least one unit test of an operation of the unit and a requirement of the operation, transmit a control signal of the operation to the unit over the communication network, receive a feedback signal from the unit in response to control signal over the communication network, analyze the feedback signal against the requirement, evaluate performance of the unit based on the analysis, and generate a report of the performance.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a schematic diagram of a performance evaluation system;

FIG. 3B is a schematic diagram of the evaluation computing device connected to the units via the communication connectors of the communication network;

FIG. 4 is an example report showing results from the performance evaluation system;

FIG. 5 is a flow chat of an example method of evaluating performance of an autonomous vehicle;

FIG. 6 is a block diagram of an example computing device;

FIG. 7 is a block diagram of an example user computing device; and

FIG. 8 is a block diagram of an example server computer device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for evaluating performance of units of a base vehicle of an autonomous vehicle are provided. As used herein, a unit includes systems and components of the base vehicle that perform specific operations of the base vehicle. For example, the units may include a steering unit, a braking unit, an engine management unit, and other units that perform certain functions of the base vehicle. The autonomy computing system is connected to units to control the base vehicle for autonomous operation. The units are tested and evaluated to determine the performance of base vehicle to ensure reliable operation. For example, testing the units may be conducted before the autonomous vehicle is commissioned for operation, during scheduled maintenance, or as needed to ensure reliable operation of the base vehicle.

Conventional methods for evaluating units on the base vehicle rely on manual testing processes that are not reproducible, prone to human error and inconsistencies. For example, manual testing may require an operator to manually perform the functions of the units, observe the response, and record performance. Each step of the manual test process is time consuming and subject to human error and inconsistencies. These error and inconsistences introduce challenges when testing multiple units and repeating tests, and across vehicles. Further, manual testing is time consuming and labor intensive.

In contrast, the disclosed performance evaluation system addresses the above-described problems in at least some known solutions. The performance evaluation system interfaces directly with the communication network connecting the autonomy computing system to the base vehicle to evaluate the units. The control signals are transmitted from the evaluation computing device to the network via the communication connectors to initiate an operation on the unit. Upon completion of the operation, the unit sends the performance evaluation system feedback signals in response to the control signals. The performance evaluation system analyzes the feedback signals against predefined performance requirements. The evaluation computing device generates reports summarizing the results of the test plan. The results may be uploaded to a server computing device and/or a web application, enabling sharing of the results and collaboration among different teams in developing the autonomous vehicle.

Further, the disclosed performance evaluation system addresses challenges of initializing and managing the communication interfaces to efficiently execute the tests and analyze the results. The evaluation computing device is configured to establish an interface with the vehicle units of the base vehicle only one time at the start of testing, thereby reducing redundant initialization, reducing latency, and optimizing the computations resource utilization for evaluating the base vehicle.

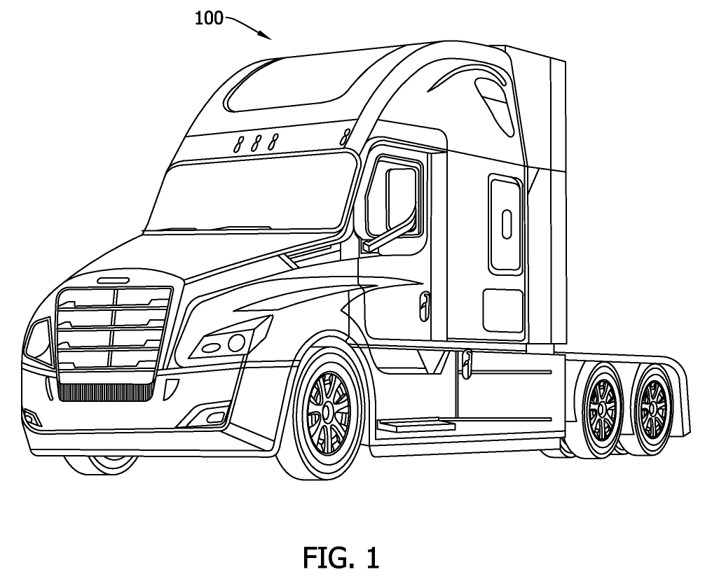

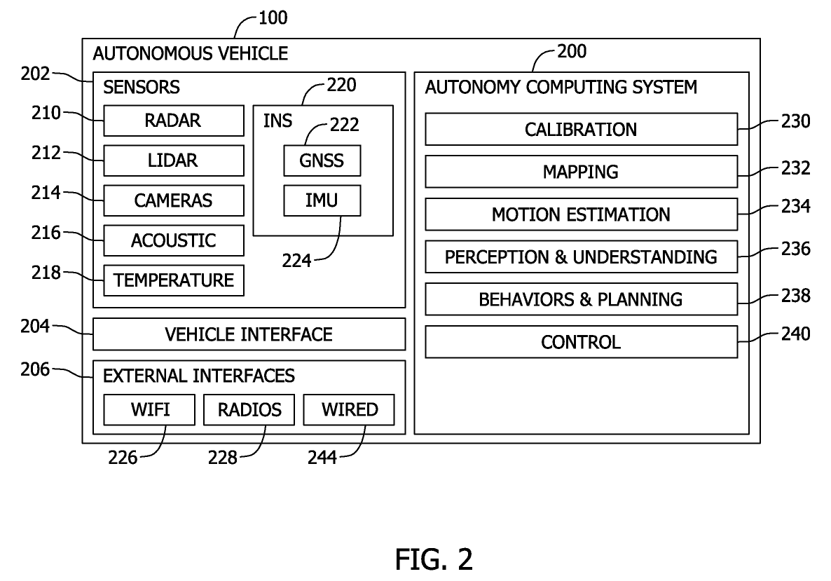

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV may have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 may be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 may operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

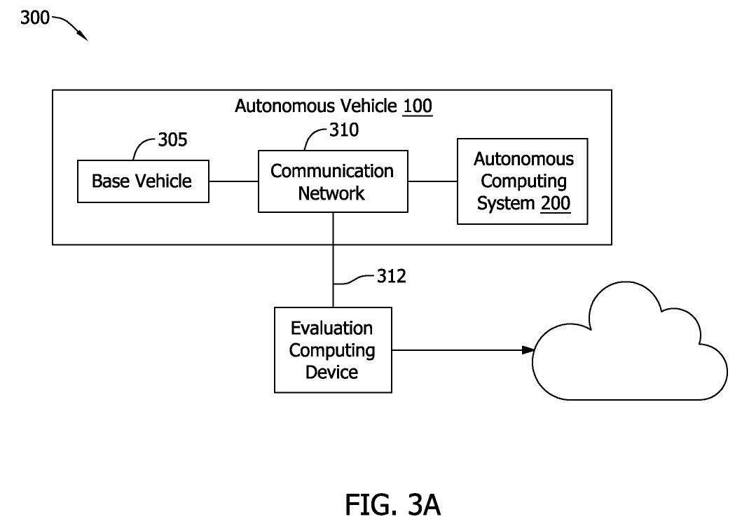

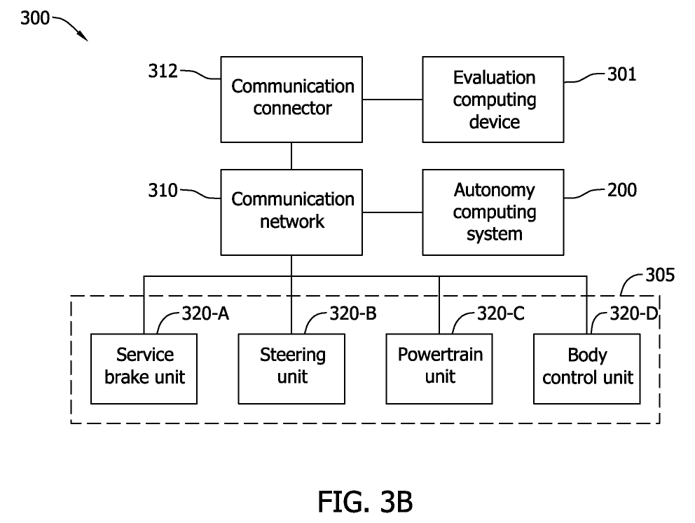

FIG. 3A is a schematic diagram of a performance evaluation system 300. In the example embodiment, performance evaluation system 300 includes an evaluation computing device 301 connected to a communication network 310 of autonomous vehicle 100, and further connected to base vehicle 305. Communication network 310 may be a controller area network (CAN). Base vehicle 305 performs the driving functions of autonomous vehicles, such as braking, steering, power train, and body control. Based on the functions, base vehicle 305 may be represented in the units 320 and/or subunits (not depicted). Autonomy computing system 200 communicates and controls operation of base vehicle 305 through communication network 310. In controlling operation of unit 320 to perform a process or function, such as engaging service brakes, autonomy computing system 200 transmits control signals to unit 320 for the process via communication network 310. Upon receipt of control signals, unit 320 performs the process and transmits feedback signals upon completion of the process.

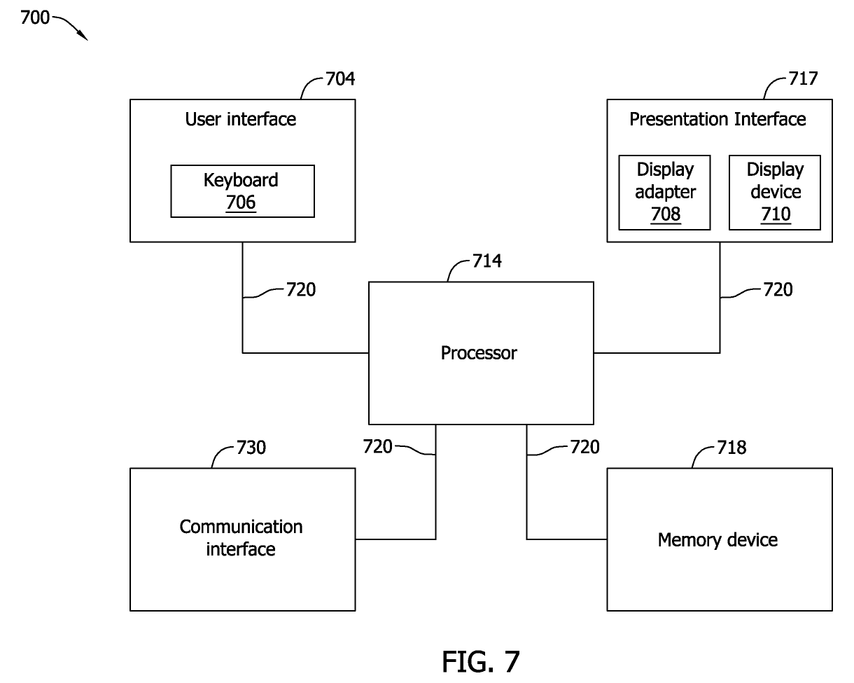

In the example embodiment, the evaluation computing device 301 includes a computing device 700 (discussed later in FIG. 7). To test base vehicle 305, evaluation computing device 301 mimics autonomy computing system 200, where evaluation computing device 301 transmits control signals to unit 320 that is to be tested, and evaluates the performance by unit 320 based on received feedback signals from unit 320. Bypassing autonomy computing system 200, evaluation computing device 301 connects to communication network 310 of base vehicle 305 via one or more communication connectors 312 to establish an interface between the evaluation computing device 301 and base vehicle 305. In various embodiments, evaluation computing device 301 executes a test plan including at least one unit test of an operation of unit 320. As used herein, a test plan refers to one or more test cases each including one or more unit tests for operational behaviors of unit 320 on base vehicle 305. Further, unit test may test the transition between modes of operation of base vehicle 305. For example, in the unit of testing mode transitions, tests are designed to test transitions between any two modes of autonomous driving. Each unit test may include one or more requirements for unit 320 performance. In various embodiments, requirements are predefined or customized for each unit test. One or more requirements stipulates standards that a unit 320 should meet. Requirements may include vehicle commissioning requirement, such as requirements stipulated for use of base vehicle 305. Unit test may evaluate an operation corresponding to multiple requirements. Requirements may include system requirements, such as requirements to commission base vehicle 305 for autonomous operation. Requirements may also include requirements for different phases of certification before public operation. In various embodiments, requirements are stored in a database accessed by or coded into performance evaluation system 300.

In some embodiments, the test plan may be modified based on the results of a previous unit test. The test plan may conditionally progress through the unit tests based on the results of a previous unit test. For example, based on the results of the previous unit test, the test plan may progress to a subsequent unit test, repeat the previous unit test, complete testing, or initiate a conditional unit test that is conditioned on the results of the previous unit test.

In the example embodiment, evaluation computing device 301 transmits control signals to unit 320 and analyzes the corresponding feedback signal to evaluate performance of the corresponding unit 320 on base vehicle 305. In the example embodiment, evaluation computing device 301 transmits a control signal over communication network 310 using interface established by communication network 310. The control signal initiates unit 320 on base vehicle 305 to execute an operation.

In the example embodiment, unit 320 generates a feedback signal corresponding to execution of the operation. The unit 320 transmits feedback signals via communication network 310 upon completion of the operation. The feedback signal may include a message ID for CAN message identification to transmit results of the unit test. In some embodiments, the feedback signal may include unit 320 data such as execution status of the operation, operational metrics, error codes, diagnostic information, and other data captured by the unit 320.

In the example embodiment, evaluation computing device 301 may analyze the feedback signal against the requirements for unit test to evaluate the performance of unit 320. For example, the performance of service brake unit 320-A may be evaluated by comparing unit 320 data of feedback signal to the requirement for brake application in the test plan. Evaluating the performance of unit 320 using the feedback signals eliminates manual logging and/or annotation, thereby increasing consistency and accuracy in performance evaluation of base vehicle 305.

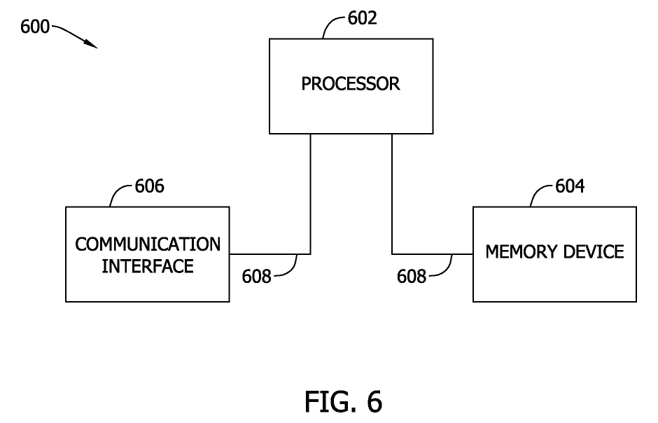

In the example embodiment, the performance evaluation system 300 includes evaluation computing device 301 configured to interface with a vehicle communication network 310 via one or more communication connectors 312. In the example embodiment, communication network 310 is a CAN bus, and communication connectors 312 facilitate communication with various units 320 within the vehicle. Evaluation computing device 301 includes user computer device 600 (discussed later in FIG. 6). Evaluation computing device 301 is programmed to establish an interface with vehicle communication network 310, transmit control signals to one or more units 320 according to the test plan, and receive feedback signals from units 320.

In the example embodiment, evaluation computing device 301 connects to vehicle communication network 310 using one or more communication connectors 312. Communication connectors 312 may include physical diagnostic ports or proprietary connectors designed for directly interfacing with communication network 310 on base vehicle 305. Upon connection, evaluation computing device 301 establishes communication to facilitate data exchange between evaluation computing device 301 and unit 320 of base vehicle 305. In this way, units 320 of base vehicle 305 may be evaluated without manual inputs or initialization of autonomy computing system 200.

In some embodiments, evaluation computing device 301 is configured to interface with vehicle communication network 310 via multiple communication channels. For example, evaluation computing device 301 may connect to an exterior CAN bus, an interior CAN bus, a redundant CAN bus, and a gateway CAN bus. These communication channels correspond to various subsystems of the vehicle, such as brakes, steering, powertrain, and body control. By supporting multiple communication channels, evaluation computing device 301 enables testing of multiple units 320, without overloading the buses, thereby reducing testing time from lag in communication. In other embodiments, communication connector 312 is single channeled and connected to multiple channels to base vehicle via a gateway configured to selectively communicate with a specific channel among the multiple channels.

In the example embodiment, for testing purposes, components of base vehicle 305 may be grouped into units 320 based on functionalities. Components may overlap among different units 320. Each unit 320 performs a distinct function, such as a service brake unit 320-A, a steering unit 320-B, a powertrain unit 320-C, and/or a body control unit 320-D (discussed later in FIG. 3B). Units 320-A, 320-B, 320-C, 320-D are depicted as examples for illustration purposes only. Base vehicle 305 may include other units 320 that performance evaluation system 300 and autonomous vehicle 100 to function as described herein. Grouping components of base vehicle 305 into units are based on requirements. Evaluation computing device 301 is configured to run test cases designed to test units 320. Test cases may include unit tests designed to test corresponding units 320 in base vehicle 305. Example test cases may be divided into modules, such as a module of tests of mode transitions, a module of service brake tests, a module of steering tests, a module of power tests, a module of parking brake tests, a module of body control tests, a module of door window and suspension tests, and a module of differential lock autonomous driving system (ADS) chime tests. The control signals instruct units 320 to perform specific operations, such as applying a braking force or adjusting a steering angle. The feedback signals returned by units 320 include data reflecting the operation of the units 320 in response to control signals.

In the example embodiment, evaluation computing device 301 initializes the communication interface once at the initialization of the test plan. During initialization, evaluation computing device 301 configures the interface, loads configuration files for executing the one or more unit tests on units 320, and established a baseline connection with communication network 310 on base vehicle 305. For example, during initialization, communication using CAN is established by reading CAN database (DBC) files to enable interpretation of signals communicated through communication network 310, where the DBC files have relatively large sizes and may take a relatively long time to process. Initialization is performed only once in testing a plurality of units according to a test plan. This approach eliminates repeated initialization between each unit test and/or modules of test plan, thereby reducing the total test time and potential inconsistencies introduced by repeated initialization, thereby increasing accuracy of test results. After the test plan is complete, evaluation computing device 301 closes the interface. Initiating the communication and closing the interface once per test plan improves testing efficiency by reducing initialization time across unit tests. A test plan may include one or more modules. Modules may be performed at the same time or sequentially, to test multiple units 320 of base vehicle 305.

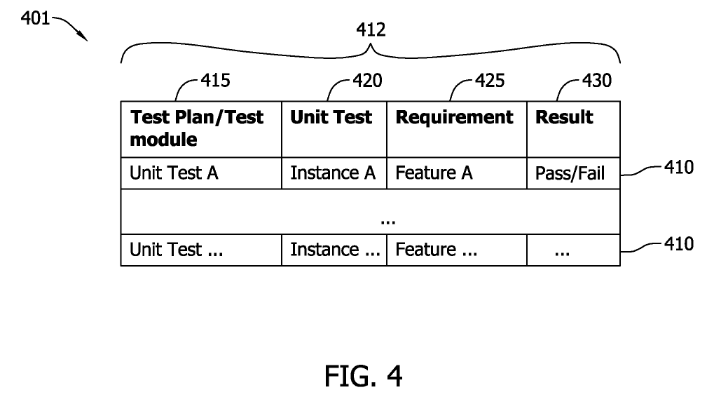

In the example embodiment, evaluation computing device 301 is further programmed to generate a report 401 (see FIG. 4 described later) detailing performance metrics and outcomes of the unit tests executed during the evaluation process. Report 401 combines the results from the test plan into a structured format, which may include tabulated entries, graphs, or summary statistics. Additionally, the report 401 is configured to include indicators for test results, such as pass or fail, and annotations highlighting any discrepancies detected during evaluation. Report 401 may be stored locally on evaluation computing device 301 and/or transmitted to a remote server for centralized logging and further analysis. In some embodiments, report 401 is formatted for compatibility with web-based applications or digital dashboards, enabling real-time access and monitoring by system operators or stakeholders. Report 401 facilitates efficient review and debugging of test plan outcomes while ensuring consistency and traceability across tests.

FIG. 3B illustrates a schematic diagram of evaluation computing device 301 connected to unit 320 via communication connectors 312 of communication network 310. For example, evaluation computing device 301 may include a laptop computing device connected via a cable to communication network 310 to evaluate unit 320 of base vehicle 305. Evaluation computing device 301 connects directly to communication network 310 to evaluate the performance of unit 320. One or more communication connectors may connect evaluation computing device 301. In the example embodiment, evaluation computing device 301 initiates a test plan to evaluate one or more unit 320 on communication network 310.

In the example embodiment, the test plan includes one or more unit tests of a unit 320 on base vehicle 305. Each unit test includes one or more requirements for analyzing the performance of unit 320. In the example embodiment, evaluation computing device 301 may analyze feedback signals from one or more of unit 320 against one or more requirements. Evaluation computing device 301 analyzes the feedback signal to determine if unit 320 passes or fails requirement of the unit test. In some embodiments, each unit test may include multiple requirements used to analyze the feedback signal. The test plan may include one or more unit tests for the operation of service brake unit 320-A. One or more unit tests may include service brake system performance (SBSP), driver takeover of the service brakes, and/or autonomy driving system (ADS) timeout on service brake unit 320-A. Each unit test includes one or more requirements. For example, the test plan may include a unit test for driver takeover of the service brakes.

In the example embodiment, evaluation computer device is programmed to transmit a control signal simulating the driver takeover of service brakes and analyze the feedback signal from service brake unit 320. The control signal may initiate an operation of service brake unit 320 such as stationary application and/or release of the service brake, and or moving application and/or release of the service brake. Further control signal may test the application of the service brake to stop the base vehicle 305 and subsequently releasing service brake. Evaluation computer device 301 analyzes the feedback signal against the requirement for the driver takeover of the service brake to determine whether service brake unit 320 passes or fails the requirement.

In the example embodiment, the test plan includes one or more unit tests for the operation of steering unit 320-B. One or more unit tests may include steering engagement, driver takeover, and/or ADS steering timeout. For example, the test plan may include a unit test for steering engagement. Evaluation computing device 301 may be programmed to transmit a control signal simulating the steering engagement of steering unit 320 according to the unit test. The control signal may operate steering unit 320-B to apply positive steering, apply negative steering, and engage zero torque mode. Evaluation computing device 301 analyzes the feedback signal from steering unit 320 against the requirement for the steering engagement to determine whether steering unit 320 passes or fails the requirement.

In the example embodiment, the test plan includes one or more unit tests for the operation of a powertrain unit 320-C. The one or more unit tests may include the engine parking brake and/or timeout of the parking brake on the powertrain unit 320-C. For example, the test plan may include a unit test for the engagement of the parking brakes and the timeout functionality of the parking brakes. The evaluation computing device 301 is programmed to transmit control signals simulating various scenarios, including applying and releasing the tractor parking brake, releasing the trailer parking brake, and transitioning between parking brake modes. The control signal may initiate an operation of the tractor parking brake or the trailer brake. In addition, the evaluation computing device 301 may test the parking brake interface by transitioning operating mode of the parking brake.

In the example embodiment, the test plan may include one or more unit tests for the operation of a body control unit 320-D. One or more unit tests may include body controller engagement and/or timeout within the body controller. Evaluation computer device 302 is programmed to transmit a control signal to body controls unit 320-D. The control signal may initiate an operation of body control unit 320-D, including lighting control, wiper, ignition switch, lock, window, suspension, and differential lock functionalities, indication commands, and other body controller operations. For example, evaluation computing device 301 may test wiper system commands such as low-speed wiper operation and activating the washer pump. Further, body control unit 320-D may also evaluate lock and window. For example, evaluation computing device 301 may evaluate body control unit 320-D by unlocking and locking the driver and passenger doors, as well as opening and closing the driver and passenger windows.

In the example embodiment, the results of each unit test are used to evaluate the performance of unit 320. The results may indicate whether unit 320 passed or failed the requirements of the unit test. Evaluation computing system 300 may analyze the results across the unit tests of a test plan to evaluate performance of the unit 320. The analysis may include determining if all requirements of the unit test were passed during the test plan. Further, evaluation computing device 301 may analyze the results to identify one or more failed requirements and determine the impact of the failed requirement on the operation of unit 320. In various embodiments, when a unit test requirement fails, the test plan may repeat the unit test to tease out the false positives and ensure the test results reflecting the performance of base vehicle 305. For example, a test of a service brake fails. Instead of outputting a failure result and proceed to the next test, the test is repeated to ensure the failure is caused by the performance of the service brake.

In some embodiments, log files are generated along with test results. In at least some known manual testing methods, when a test fails, the operator turns on the function of generating a log file and re-run the test, hoping to reproduce the failure and catch the log file. The known methods are time consuming. In contrast, the function of generating log files from communication network 310 is provided in the systems described herein. The corresponding log file is caught at the time of the failure. The log files may be combined with report 401 and provided to a reviewer and/or uploaded to a remote server device 802. The log files may include the same identifiers, such as time stamps, as in report 401. A reviewer may allocate the corresponding log file or corresponding sections in the log files to the failure, thereby diagnosing the causes of the failure.

FIG. 4 illustrates an example report 401 showing results 410 from the generated report 330. In the example embodiment, evaluation computing device generates a report 401 including the evaluated performance of unit 320. Compared to known manual testing methods, generating and aggregating test results by evaluation computing device 301 is advantageous in saving time in manual labor and eliminating human errors and/or inconsistencies. Generated report 401 includes one or more fields 412. Fields 412 include data captured by evaluation computing device 301. Fields 412 may include test plan data, unit 320 data, logs from the communication network, results 410, and other data resulting from evaluation of the unit. Further, the fields 412 may be individualized for each generated report 401. For example, the report 401 may include an identification of autonomous vehicle 100, the name of test plan 415, the name of unit test 420 corresponding to result 410, requirement of unit test 425, the name of the testing site, and/or result 430 of unit test 420. The list of fields may be customized based on the need in testing and review. The list of fields may be pre-defined or user defined. Report 401 may include a relatively large number of tests, e.g., 200 or more, and a relatively large number of reports 401 are generated during testing for a specific autonomous vehicle at different life cycles and different models or generations of autonomous vehicles. To increase conveniency in comparison and review of reports 401, the output format and/or display format of fields 412 is consistent. In some embodiments, an indicator may be used to distinguish different test results. For example, the test results may be color-coded, where passed tests are shown with green and failed tests are shown as yellow.

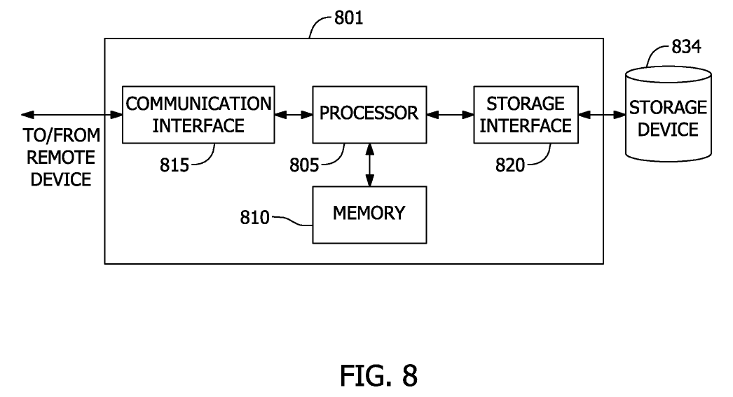

In the example embodiment, report 401 may be generated in a format compatible with the web application. For example, the evaluation computing device may generate report 401 as a pdf file, table, or other digital format compatible with a remote server device, e.g., a server computing device 802 (see FIG. 8, described later). Report 401 may be stored locally on evaluation computing device. Storing report 401 on evaluation computing device enables performance of the evaluation of unit in environments having have limited or no network access to connect to remote server device. Evaluation computing system may locally store the generated report 401 and subsequently upload report 401 upon sufficient connection to the internet. Further, report 401 needs to be authenticated before being uploaded to remote server device 802. Saving report 401 locally reduces or eliminates effects of uploading to remote server device on the speed of performing the tests.

In the example embodiment, report 401 may be uploaded to remote server device 802 to centralize results 410 across multiple test plans. Uploading reports 401 to remote server device 802 is advantageous in sharing testing results among various reviewers without limitation of geographical locations. In various embodiments, one or more user computer devices access remote server device to view the generated reports 401. The remote server device may display the generated reports 401 as a dashboard on the connected user computer devices. The dashboard may include one or more fields 412 from the generated report 401. In some embodiments, the dashboard may display indicators representing whether the unit passed or failed the at least one unit 420 test of the test plan 415 as the result 430. The dashboard may be modified to change the displayed information from report 401.

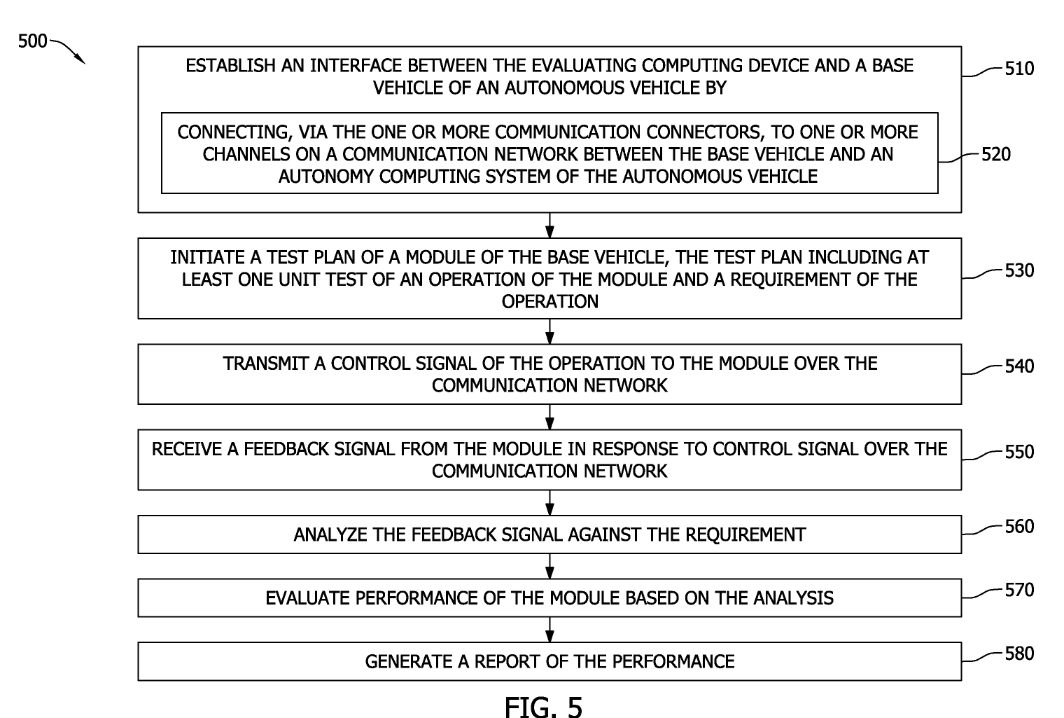

FIG. 5 is a flow chart of an example method of use for the performance evaluation system. Method 500 includes establishing 510 an interface between evaluating computing device and a base vehicle of an autonomous vehicle. In various embodiments, the evaluation computing device connects to a communication network of the vehicle using a communication connector. Method 500 also includes connecting 520, via one or more communication connectors, to one or more channels on a communication network between the base vehicle and an autonomy computing system of the autonomous vehicle. Further, method 500 includes initiating 530 a test plan of a unit of the base vehicle, the test plan including at least one unit test of an operation of unit and a requirement of the operation. Method 500 also includes transmitting 540 a control signal of the operation to the unit over the communication network. Additionally, method 500 includes receiving 550 a feedback signal from unit in response to control signal over communication network. Method 500 also includes analyzing 560 the feedback signal against the requirement. Further, method 500 includes evaluating 570 the performance of the unit based on the analysis. Method 500 may also include generating 580 a report of the performance.

FIG. 6 is a block diagram of an example computing device 600. Autonomy computing system 200 includes one or more computing device 600. In the example embodiment, computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Evaluation computing device 301 described herein may be any suitable computing device 700 and software implemented therein. FIG. 7 is a block diagram of an example user computing device 700. In the example embodiment, computing device 700 includes a user interface 704 that receives at least one input from a user. User interface 704 may include a keyboard 706 that enables the user to input pertinent information. User interface 704 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 700 includes a presentation interface 717 that presents information, such as input events and/or validation results, to the user. Presentation interface 717 may also include a display adapter 708 that is coupled to at least one display device 710. More specifically, in the example embodiment, display device 710 may be a visual display device, such as a cathode ray tube (CRT), a liquid crystal display (LCD), a light-emitting diode (LED) display, and/or an “electronic ink” display. Alternatively, presentation interface 717 may include an audio output device (e.g., an audio adapter and/or a speaker) and/or a printer.

Computing device 700 also includes a processor 714 and a memory device 718. Processor 714 is coupled to user interface 704, presentation interface 717, and memory device 718 via a system bus 720. In the example embodiment, processor 714 communicates with the user, such as by prompting the user via presentation interface 717 and/or by receiving user inputs via user interface 704. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are for illustration purposes only, and thus are not intended to limit in any way the definition and/or meaning of the term “processor.”

In the example embodiment, memory device 718 includes one or more devices that enable information, such as executable instructions and/or other data, to be stored and retrieved. Moreover, memory device 718 includes one or more computer readable media, such as, without limitation, dynamic random access memory (DRAM), static random access memory (SRAM), a solid state disk, and/or a hard disk. In the example embodiment, memory device 718 stores, without limitation, application source code, application object code, configuration data, additional input events, application states, assertion statements, validation results, and/or any other type of data. Computing device 700, in the example embodiment, may also include a communication interface 730 that is coupled to processor 714 via system bus 720. Moreover, communication interface 730 is communicatively coupled to data acquisition devices.

In the example embodiment, processor 714 may be programmed by encoding an operation using one or more executable instructions and providing the executable instructions in memory device 718. In the example embodiment, processor 714 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

FIG. 8 illustrates an example configuration of a server computer device 801 such as evaluation computing device 301. Server computer device 801 also includes a processor 805 for executing instructions. Instructions may be stored in a memory area 830, for example. Processor 805 may include one or more processing units (e.g., in a multi-core configuration).

Processor 805 is operatively coupled to a communication interface 815 such that server computer device 801 is capable of communicating with a remote device or another server computer device 801. For example, communication interface 815 may receive data from system 12, via the Internet.

Processor 805 may also be operatively coupled to a storage device 834. Storage device 834 is any computer-operated hardware suitable for storing and/or retrieving data. In some embodiments, storage device 834 is integrated in server computer device 801. For example, server computer device 801 may include one or more hard disk drives as storage device 834. In other embodiments, storage device 834 is external to server computer device 801 and may be accessed by a plurality of server computer devices 801. For example, storage device 834 may include multiple storage units such as hard disks and/or solid state disks in a redundant array of independent disks (RAID) configuration. storage device 834 may include a storage area network (SAN) and/or a network attached storage (NAS) system.

In some embodiments, processor 805 is operatively coupled to storage device 834 via a storage interface 820. Storage interface 820 is any component capable of providing processor 805 with access to storage device 834. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 805 with access to storage device 834.

An example technical effect of the methods, systems, and apparatus described herein includes at least one of: (a) automizing testing by communicating with the base vehicle via over the communication network or (b) generation of the report to display performance results.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A performance evaluation system for evaluating performance of a base vehicle of an autonomous vehicle, the system comprising:
one or more communication connectors; and
an evaluation computing device comprising at least one processor in communication with at least one memory device, the at least one processor programmed to:
establish an interface between the evaluating computing device and a base vehicle of an autonomous vehicle by:
connecting, via the one or more communication connectors, to one or more channels in a communication network between the base vehicle and an autonomy computing system of the autonomous vehicle;
initiate a test plan of a unit of the base vehicle, the test plan including at least one unit test of an operation of the unit and a requirement of the operation;
transmit a control signal of the operation to the unit over the communication network;
receive a feedback signal from the unit in response to the control signal over the communication network;
analyze the feedback signal against the requirement;
evaluate performance of the unit based on the analysis; and
generate a report of the performance.

2. The system of claim 1, wherein the at least one processor is further programmed to:
connect to the communication network via a plurality of channels in the one or more communication connectors.

3. The system of claim 1, wherein the at least one processor is further programmed to:
generate a log file of a failed test in the at least one unit test; and
diagnose cause of failure in the failed test based on the log file.

4. The system of claim 1, wherein the at least one processor is further programmed to:
initialize the interface before initiating one or more test plans of one or more units;
test the one or more units by executing the one or more test plans; and
close the interface after completing testing.

5. The system of claim 1, wherein the test plan of the unit is generated based on one or more requirements of the unit.

6. The system of claim 1, wherein the at least one processor is further programmed to:
repeat testing the unit based on results of a previous unit test.

7. The system of claim 1, wherein the at least one processor is further programmed to:
generate the report having one or more fields represented in one or more predefined formats.

8. The system of claim 1, wherein the at least one processor is further programmed to:
generate the report having one or more individualized fields.

9. The system of claim 1, wherein the at least one processor is further programmed to:
generate the report in a format compatible with a web application, the web application hosted by a server computing device;
store the report locally on the evaluation computing device; and
upload the report to the server computing device when an Internet connection of the evaluation computing device is available.

10. The system of claim 1, wherein generating the report includes an indicator of the performance.

11. The system of claim 1, wherein the at least one processor is further programmed to:
test transitioning between modes of operation of the autonomous vehicle.

12. A method for evaluating performance of an autonomous vehicle, the method comprising:
establishing an interface between the evaluating computing device and a base vehicle of an autonomous vehicle by:
connecting, via one or more communication connectors, to one or more channels in a communication network between the base vehicle and an autonomy computing system of the autonomous vehicle;
initiating a test plan of a unit of the base vehicle, the test plan including at least one unit test of an operation of the unit and a requirement of the operation;
transmitting a control signal of the operation to the unit over the communication network;
receiving a feedback signal from the unit in response to control signal over the communication network;
analyzing the feedback signal against the requirement;
evaluating performance of the unit based on the analysis; and
generating a report of the performance.

13. The method of claim 12, further comprising:
generating a log file of a failed test in the at least one unit test; and
diagnosing cause of failure in the failed test based on the log file.

14. The method of claim 13, further comprising:
initializing the interface before initiating one or more test plans of one or more units;
testing the one or more units by executing the one or more test plans; and
closing the interface after completing testing.

15. The method of claim 12, further comprising:
generating the test plan based on one or more requirements of the unit.

16. One or more non-transitory computer-readable media for evaluating performance of an autonomous vehicle, the one or more non-transitory media comprising a plurality of instructions stored thereon that, in response to being executed, cause a system to:
establish an interface between an evaluating computing device and a base vehicle of an autonomous vehicle by:
connecting, via one or more communication connectors, to one or more channels in a communication network between the base vehicle and an autonomy computing system of the autonomous vehicle;
initiate a test plan of a unit of the base vehicle, the test plan including at least one unit test of an operation of the unit and a requirement of the operation;
transmit a control signal of the operation to the unit over the communication network;
receive a feedback signal from the unit in response to control signal over the communication network;
analyze the feedback signal against the requirement;
evaluate performance of the unit based on the analysis; and
generate a report of the performance.

17. The one or more non-transitory computer-readable media of claim 16, wherein the plurality of instructions further cause the system to:
connect to the communication network via a plurality of channels in the one or more communication connectors.

18. The one or more non-transitory computer-readable media of claim 17, wherein the plurality of instructions further cause the system to:
generate a log file of a failed test in the at least one unit test; and
diagnose cause of failure in the failed test based on the log file.

19. The one or more non-transitory computer-readable media of claim 16, wherein the plurality of instructions further cause the system to:
generate the report having one or more individualized fields.

20. The one or more non-transitory computer-readable media of claim 16, wherein the plurality of instructions further cause the system to:
generate the report in a format compatible with a web application, the web application hosted by a server computing device;
store the report locally on the evaluation computing device; and
upload the report to the server computing device when an Internet connection of the evaluation computing device is available.
